(19) United States
(12) Patent Application Publication
(10) Pub. No.: US 2018/0060263 A1
(43) Pub. Date: Mar. 1, 2018

(54) UPDATED REGION COMPUTATION BY THE BUFFER PRODUCER TO OPTIMIZE BUFFER PROCESSING AT CONSUMER END

(71) Applicant: Qualcomm Innovation Center, Inc., San Diego, CA (US)

(72) Inventors: Ramkumar Radhakrishnan, San Diego, CA (US); Dileep Marchya, Hyderabad (IN); Mastan Manoj Kumar Amara Venkata, San Diego, CA (US)

(21) Appl. No.: 15/252,041

(22) Filed: Aug. 30, 2016

(51) Int. Cl. G06F 13/40; G06F 13/42

(52) U.S. Cl. CPC G06F 13/4027; G06F 13/4265

(57) ABSTRACT

A method and device for processing buffers of updated content for graphical display on a computing device are provided. The method may comprise receiving, from a consumer of the buffers, a buffer depth of a destination pipeline, processing, by a producer of the buffers, an updated region of one or more buffers based on the buffer depth, and forwarding the processed updated buffer area from the producer to the consumer.

### FIELD OF THE DISCLOSURE

The present disclosure relates generally to buffer processing in systems-on-a-chip. More specifically, but without limitation, the present disclosure relates to the computation of updated regions by a buffer producer in order to improve buffer processing.

### BACKGROUND

Modern personal computing devices such as smartphones, tablet computers, and desktop personal computers are capable of displaying high quality video and graphics from a multitude of applications including web browsers and video games. Improvements in battery life, performance, and speed are continuously being sought for these types of high-quality graphics rendering devices.

In order to improve graphics processing, some devices utilize integrated systems-on-a-chip (SoC), in which multiple types of specialized processing units may work together to most efficiently utilize processing resources. In some SoCs, such as those used in mobile devices, a graphics processing units (GPU), may work in conjunction with a central processing units (CPU) and/or a mobile display processing unit (MDP). In such environments, a GPU is typically implementing most parts of a graphics rendering pipeline, for which it is well suited, while an MDP is used for compositing layers of rendered images onto a device display. Other pieces of hardware and/or software may also be used in various processes, which are also known as pipelines, that ultimately result in the display of a visual image onto a screen.

The nature of high-quality graphics rendering is that visual content is updated very frequently, and often, individual frames of visual content, which are stored as buffers in memory and accessed for rendering and composition, are each processed individually. These buffers are often processed and sent through multiple hardware processing components in order to provide seamless displays of changing content. The processing of each entire buffer requires processing resources, battery power, and bandwidth between each hardware component of a pipeline. Often, between subsequent buffers, the visual content does not change completely, but rather, only a portion of the visual content of a buffer appears different from its immediately previous buffer. That is, only a particular region of a buffer is updated with new visual content in relation to a previous one. As a result, opportunities exist to save processing resources, power, and bandwidth by processing only an updated region rather than an entire region of a buffer.

### SUMMARY

One aspect of the present disclosure provides a method for processing buffers of updated content for graphical display on a computing device. The method may comprise receiving, from a consumer of the buffers, a buffer depth of a destination pipeline, processing, by a producer of the buffers, an updated region of one or more buffers based on the buffer depth, and forwarding the processed updated buffer area from the producer to the consumer.

Another aspect of the disclosure provides a computing device configured to process buffers of updated content for graphical display. The device may comprise a memory configured to store a plurality of buffers of content for graphical display, wherein one or more of the buffers comprises updated content in relation to one or more other buffers. The device may also comprise a processor configured to produce the buffers comprising updated content and a compositor configure to composite the buffers comprising updated content. The processor and the compositor may then be configured to receive, from the compositor, a buffer depth of a destination pipeline, process, by the processor of the buffers, an updated region of one or more buffers based on the buffer depth, and forward the processed updated buffer area from the processor to the compositor.

Yet another aspect of the disclosure provides a non-transitory, tangible computer readable storage medium, encoded with processor readable instructions to perform a method for processing buffers of updated content for graphical display on a computing device. The method may comprise receiving, from a consumer of the buffers, a buffer depth of a destination pipeline, processing, by a producer of the buffers, an updated region of one or more buffers based on the buffer depth, and forwarding the processed updated buffer area from the producer to the consumer.

### BRIEF DESCRIPTION OF THE DRAWINGS

FIG. 1 is a logical block diagram of a computing device that may implement aspects of the present disclosure.

FIG. 2 is a logical block diagram of a flow of buffers through a rendering and composition pipeline.

FIG. 3 is a logical block diagram of a flow of buffers through a rendering and composition pipeline wherein a destination pipeline buffer depth is greater than one, and how errors in a display can result.

FIG. 4 is a logical block diagram of a flow of buffers through a rendering and composition pipeline wherein a destination pipeline buffer depth is greater than one, and depicting components of the present disclosure for processing updated regions.

FIG. 5 is a diagram showing two versions of a destination pipeline at different times as updated buffers move through them.

FIG. 6 is a flowchart depicting a method of the present disclosure.

FIG. 7 is a high-level logical block diagram of a computing device that may implement aspects of the present disclosure.

### DETAILED DESCRIPTION

In advanced processors for high-quality graphics rendering, a graphics processing unit is typically responsible for most of the processing of visual images, which it accomplishes by accessing data (e.g., bitmaps) stored in a physical memory and processing that data through a graphics rendering pipeline. Each frame of visual image data is stored in a buffer in physical memory and is commonly referred to as a buffer as it moves through various steps of rendering and composition and ultimately gets displayed on a screen. Throughout the disclosure, frames of visual image data may be referred to as “buffers.” Graphics rendering pipelines typically perform steps known in the art such as shading and rasterization, the sum process of which is commonly referred to as “rendering.” Once the rendering of a buffer is complete, it may get composited onto a display. In many devices, a dedicated compositor or mobile display processing unit (MDP) may be responsible for composing the buffer onto a display.

Some graphics processors may work on multiple buffers at a time in order to provide a seamless output of buffers to a compositor or MDP. Though GPUs and MDPs are specifically referenced throughout the present disclosure, it is contemplated that aspects of the disclosure may apply to different types of processors and compositors as well. As such, a buffer processor may be referred to as a “producer” of buffers and an MDP or other compositor may be referred to as a “consumer” of buffers. Another type of “consumer” of buffers may be, for example, a rotator that rotates buffers 90 degrees at a time for display.

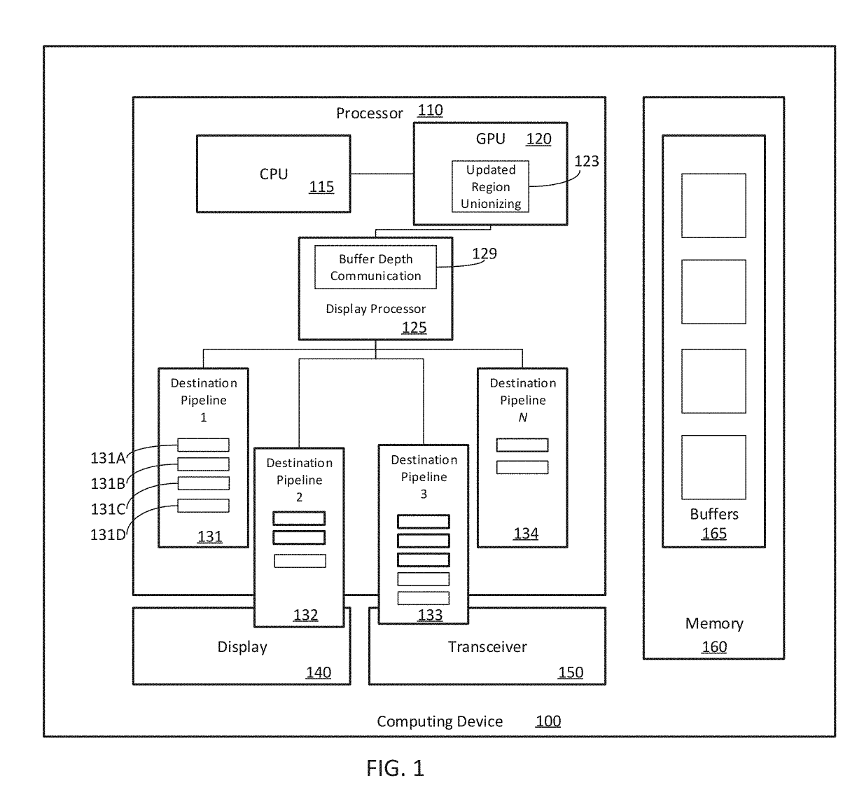

FIG. 1 is a logical block diagram of a computing device 100 that may implement aspects of the present disclosure. FIG. 1 is not intended to be a hardware diagram, but the components depicted may be implemented by hardware alone, software alone, firmware, or a combination of hardware and software. Computing device 100 in the embodiment shown comprises an processor 110, which may be implemented by an integrated SoC or other multi-core processor. The processor 110 itself comprises a CPU 115 and a GPU 120, which may itself comprise an Updated Region Unionizing Component 123. The computing device 100 may also comprise a Display Processor 125, which may be implemented by an MDP or other compositor, and may itself comprise a Buffer Depth Communication Component 127. The computing device 100 may also comprise a memory 160 having a plurality of buffers 165. In addition, the computing device 100 may also comprise several other hardware components such as a display 140 and a transceiver 150. Also shown are a plurality of destination pipelines 131-134. The destination pipelines 131-134 represent different composition outcomes that may occur after rendering, examples of which will be described later in the disclosure. In FIG. 1, the GPU 120 may function as a buffer “producer” and the Display Processor 125 may function as a buffer “consumer.”

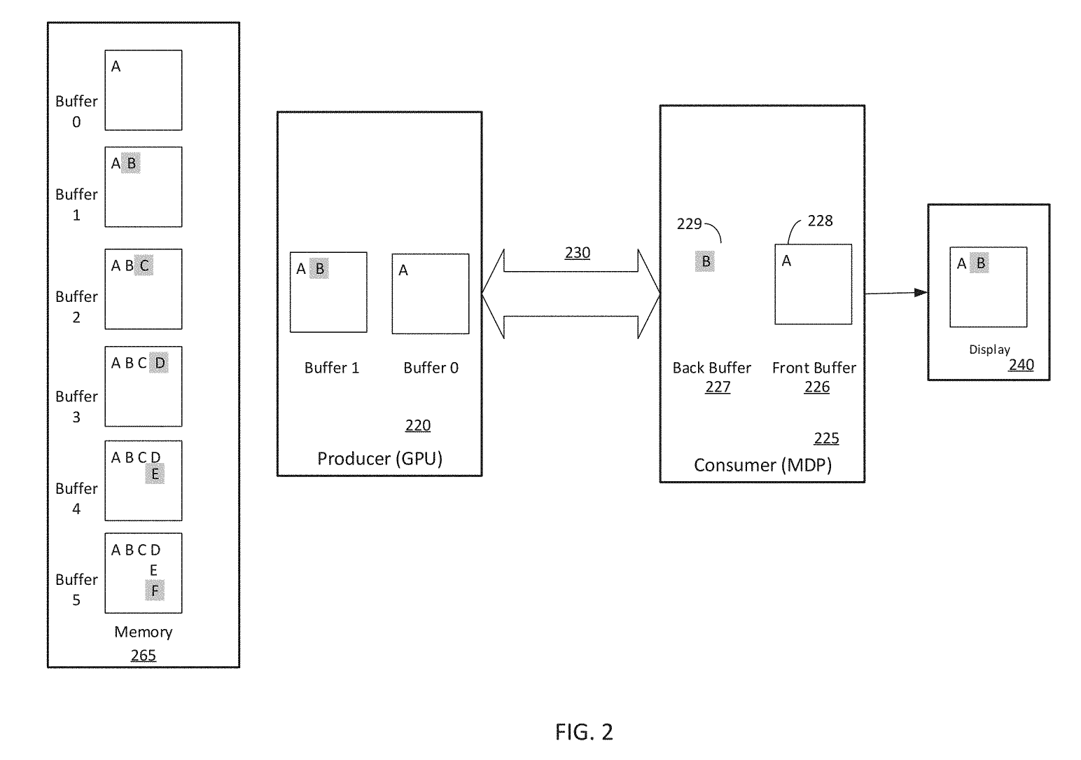

In existing approaches, a producer can provide a consumer with just the processed updated region information for a buffer instead of an entire newly processed buffer. This approach is advantageous because instead of fetching an entire buffer from the producer for composition, a consumer may instead just fetch the updated portion, which saves bandwidth, and therefore power, between the consumer and the producer. The updated region information can be used by the consumer to composite only the updated portion of the region rather than re-composing regions that can be reused. FIG. 2 is a high-level logical block diagram depicting a flow of buffers with updated regions being processed and composed onto a display. The flow is depicted visually from left to right for purposes of understanding, and the components depicted herein may be viewed as a simplified version of components depicted in FIG. 1. For example, the memory 265 in FIG. 2 may correspond to the memory 165 in FIG. 1, the producer 220 may correspond to the GPU 120, the consumer 225 may correspond to the display processor 125, and the display 240 may correspond to the display 140.

As shown in FIG. 2, the memory 265 has six buffers, labeled Buffer 0-Buffer 5. These buffers may represent frames as they are to be visually presented to a user sequentially from an application, with Buffer 0 presented first, Buffer 1 being presented second, etc. Buffers 0-5 are depicted here in a highly simplistic manner, and are depicted similarly as they move through the memory 265, producer 220, consumer 225, and ultimately the display 240, but it will be recognized by those skilled in the art that the data represented by the buffer depictions may be transformed through different forms within the different components. For example, the buffer data may exist as a bitmap in the memory 265 and then as actual shaded pixels on a screen on the display 240. Therefore, each buffer 0-5, drawn in the figures as squares with simple letters and shading, may be thought of as visual representations of what eventually gets displayed on a screen of a computing device.

Each Buffer 1-5 is depicted as containing both an updated region and a constant (i.e., non-updated) region in relation to its immediately preceding buffer. For example, Buffer 0 is displayed with the letter “A” in its top left corner and nothing else in the rest of the buffer. Buffer 1, the subsequent buffer, also shows the letter “A” in the top left corner as well as some “updated” content in the form of the shaded letter “B.” The rest of Buffer 1 is blank, or “constant,” similarly to Buffer 0. Therefore, the “updated region” or “updated content” (which may be referred to interchangeably) comprises the letter “B” in Buffer 1. Similarly, the updated content in Buffer 2 as compared to Buffer 1 comprises the letter “C,” the updated content in Buffer 3 as compared to Buffer 2 comprises the letter “D,” and so forth.

Buffers 0 and 1 are shown within the producer 220 to represent that the producer is processing (e.g., in a graphics rendering pipeline) the bitmap data that the producer 220 fetched (i.e., read) from the memory 265. The producer 220 may fully render Buffer 0 and then either fully render all of Buffer 1, or may simply render the updated region of Buffer 1 and re-use the constant region of Buffer 0 for Buffer 1, as is done in some existing approaches to conserve processing power. The number of buffers that are being processed at one time by a producer may vary depending on the rendering pipeline of the producer, but in FIG. 2 the number of buffers is depicted as two. Once Buffer 0 and Buffer 1 have been processed by the producer 220, they are sent to the consumer 225. The buffers may be sent via a bus 230 connecting the producer 220 and the consumer 225, as is known in the art of multi-core processors. The bus 230 is represented by a wide arrow to represent that a bus 230 has a bandwidth. The process of the consumer 225 receiving buffers from the producer 225 may also be known as “fetching” on the part of the consumer. The consumer 225 may fetch the data it needs in order to composite an image onto the display 240. If the consumer 225 only needs to fetch data for an updated region rather than an entire buffer in order to compose an image on to a display, less bandwidth on the bus will be used, which saves power in comparison to fetching an entire buffer. Aspects of the present disclosure are directed to saving power in this manner by only fetching updated regions instead of whole buffers.

In many current approaches, a compositor utilizes a front buffer and a back buffer in order to facilitate the seamless display of updated content. In such implementations, the front buffer may be the buffer that is pointed to in order to paint the composited image onto a display. The back buffer may be used for rasterizing or compositing the subsequent buffer data while the image is being displayed on the front buffer. Then, when it is time to display the updated content, the back buffer data may be utilized. For example, both the front and back buffers may be pointed to simultaneously, or the back buffer updated region may be composited onto the existing data on the front buffer. In other words, updated region information from a back buffer may be composed onto a previous “dirty buffer” (i.e., a buffer already having image data written on it). Having two buffers may minimize or eliminate any delay in visual displays in cases wherein the updating of content takes longer than the actual display of current content. As a result, it is common for a compositor that is rendering straight onto a hardware display to have exactly two buffers; one for a current display of content and one for the rasterization of updated content. When a compositor and its resulting display utilizes two buffers at once, they can be said to have a “buffer depth” of one.

Recent advances in display technology have created certain use cases in which a more complex pipeline than “compositor to display” exists after composition takes place. For example, on a smartphone or tablet computer, images from an application (e.g., a movie or video game) may be rendered and composited for an vertical orientation of a smartphone display but may also require buffers for rotating a composited image 90 degrees into a horizontal orientation. This rotation requires the implementation of a rotation pipeline which comprises additional hardware and/or software on (or in addition to) an MDP. Because this rotation pipeline comprises additional components, it also requires more buffers in order to provide a seamless display. Most commonly, the buffer depth (i.e., the number of updated region buffers that may be held at a time including a currently displayed buffer) for a rotation pipeline is two. That is, two total buffers may be used in the rotation pipeline. This rotation pipeline is one example of a “destination pipeline” as depicted in FIG. 1 (destination pipelines 131-134).

Another example of a destination pipeline that requires a buffer depth greater than one is a “write back for wireless display” pipeline. Some smartphone and tablet devices, such as ones that can implement aspects of the present disclosure, can perform wireless display mirroring, which is a function that allows images that are rendered on a mobile device to be wirelessly displayed on a remote display device such as a television, a monitor, or another computing device. Depending on the implementation, the composited images may be displayed on the local device display and the remote wireless display simultaneously, but in other embodiments, the image will be displayed solely on the remote device instead of compositing the image at the local device. A write back for wireless display pipeline involves several additional hardware and/or software components beyond the compositor. It may involve other components on an SoC, on the local computing device, and on the remote device. Such components may include an encoder, a maxxer, and encryption hardware. In order to ensure that resulting images display continuously, it may be advantageous to provide separate buffers for each hardware component to work on simultaneously. As a result, the buffer depth of the destination pipeline for the write back for a wireless display may vary between three and five.

Turning back to FIG. 2, in cases where the destination pipeline simply comprises the compositor and the display, and the buffer depth is exactly two, the producer 220 sending only updated region information to the consumer 225 is advantageous. As shown, the consumer could fetch a first full buffer 228, (Buffer 0 from the producer 220) for the front buffer 226, and just the updated region information 229 (Buffer 1 from the producer 220) simultaneously. The image ultimately displayed on the display 240 represents the result of the first full buffer 228 and the updated region information 229 being composited together.

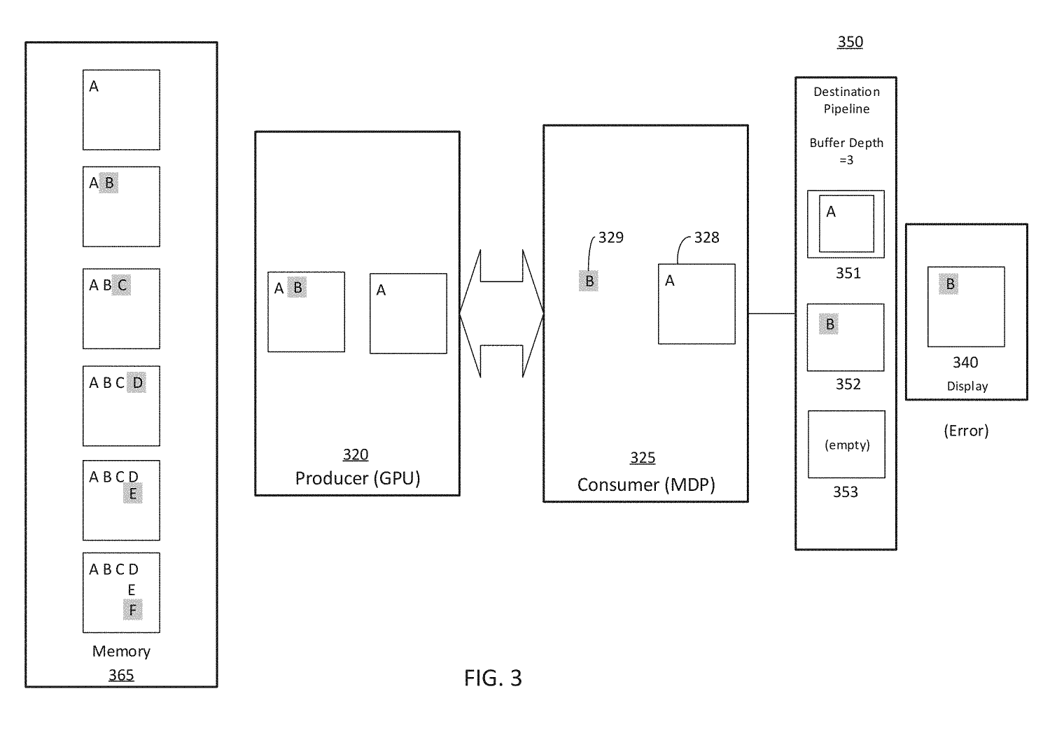

However, when the buffer depth of a destination pipeline is greater than one, and updated regions from more than one buffer may be fetched by the consumer simultaneously, errors in the display can result. FIG. 3 illustrates a similar overall rendering and composition pipeline, but with an additional destination pipeline 350 that exists after the compositor 325. The destination pipeline 350 has a buffer depth of three, meaning that it uses a total of three buffers. If the consumer only fetches one buffers at a time, as would normally take place, the result may be that only an updated region of one of the buffers gets displayed. For example, the updated region information 329 at the consumer 325, which comprises only the letter “B,” may end up being displayed alone, without the previous constant content of the full buffer 328. There are several reasons why only the updated region 329 might be displayed. As shown, the destination pipeline 350 has a first pipeline buffer destination 351, a second pipeline buffer destination 352, and a third pipeline buffer destination 353. If the consumer 325 only fetches one buffer from the producer 320, the first pipeline buffer destination 351 may receive a first fully processed buffer 328, the second pipeline buffer destination 352 may receive the updated region only 329, and the third pipeline buffer destination 353 may remain empty, without a buffer. The display 340 shows an erroneous display in which only the second buffer 352, which contains just the updated region, is shown. In order to avoid display errors in destination pipelines where the buffer depth is greater than one, current approaches result in processing each full buffer rather than just the updated regions of subsequent buffers. This scenario, in which each full buffer is processed each time, creates an inefficient utilization of hardware resources.

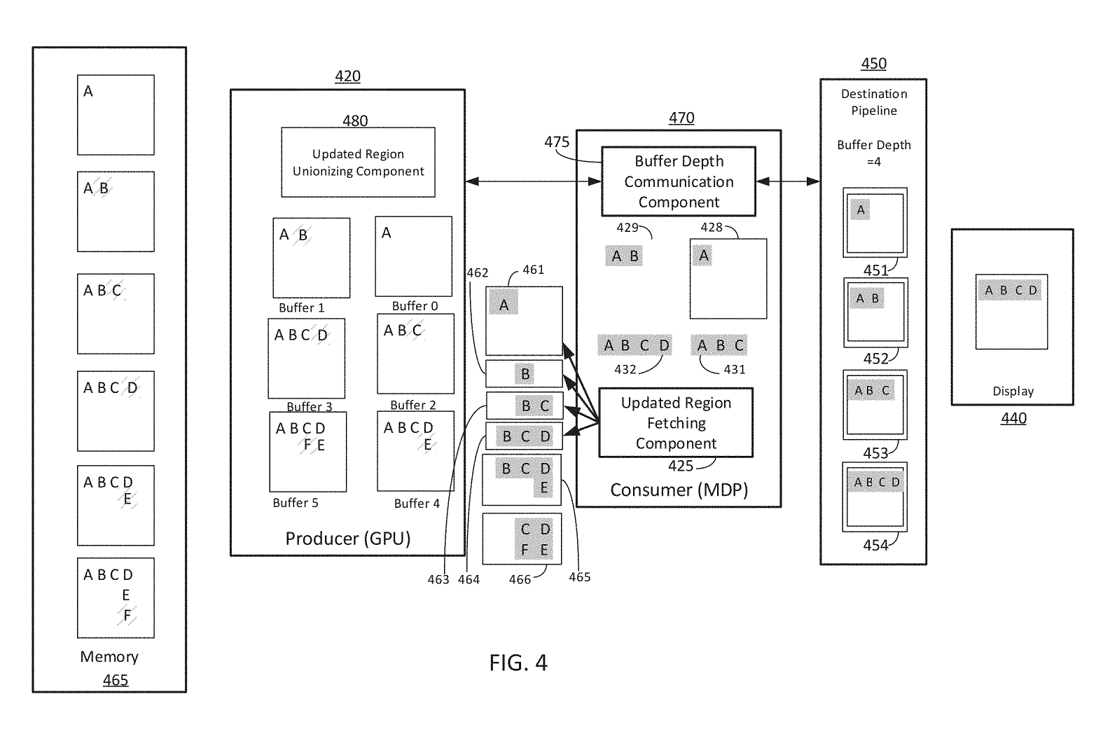

An aspect of the present disclosure provides a buffer depth communication component within an MDP for determining the buffer depth of a destination pipeline for processed buffers and communicating the buffer depth to the buffer producer. Another aspect provides an updated region unionizing component for processing necessary updated regions based on the buffer depth of a destination pipeline. Turning to FIG. 4, shown is a rendering and composition pipeline of the present disclosure in which a destination pipeline 450 has a buffer depth of four. In the diagram, when highlighted regions are depicted in the memory 465 and the producer 480, they are highlighted simply to identify what content is new in relation to existing content. In contrast, when regions are highlighted after the producer processes the updated regions, they are highlighted differently to show what has been processed together (in fetched regions 461-466) and what will ultimately be newly composited on a buffer in the destination pipeline 450.

The consumer 470 in the embodiment shown comprises a buffer depth communication component 475, which determines the buffer depth of the destination pipeline 450 and then communicates it to the producer 420. Based on the buffer depth, a updated region unionizing component 480 within the producer 420 can unionize, or gather, not just the updated region information for one subsequent buffer, but for as many subsequent buffers as necessary for a given destination pipeline.

The producer 420 in FIG. 4 shows Buffers 0-4 gathered in the producer 420 for processing. It is contemplated that in various implementations, a producer may be capable of fetching as many buffers from a memory 465 at once as necessary to execute the unionizing, or may be capable of waiting until enough buffers are gathered in the producer 420 to execute the unionizing. The updated region fetching component 425 of the consumer 470 may fetch the buffers. To unionize the updated regions, the producer 420 identifies only the updated regions on a number of subsequent buffers, after a first buffer, that corresponds to the particular total buffer depth provided. In the example of FIG. 4, the buffer depth is four, so after the first buffer 0, the producer identifies the updated regions on Buffer 1, Buffer 2, and Buffer 3. Buffer 0, which is represented as a shaded “A” in the top corner of a blank square, is depicted in such a manner to represent that it is the first buffer of an image, and as such, is fully processed by itself. After identifying the updated regions in subsequent buffers after Buffer 0, the producer 420 then processes each of these updated regions together; that is, their processing is unionized. The sequence of the processing Buffers 0-4 at the producer 420 and sending the processed information to the consumer 470, is depicted through “fetched regions” 461-466,” and takes place as follows: First, the producer 420 processes the full Buffer 0 (comprising content “A”) and it is fetched at fetched region 461 by the updated region fetching component 425. It is contemplated that the updated region fetching component 425 may fetch updated regions one at a time or several at a time. In the diagram, the updated region fetching component 425 is shown with arrows fetching the first four fetched updated regions 461-464.

Then, the producer processes just the updated region of Buffer 1 (comprising content “B”) that is updated in comparison to Buffer 0 and it is fetched by the consumer 470, as shown in fetched region 462. The consumer now has the full content of Buffer 0 at a first consumer buffer location 428, and both the original content (“A”) and the updated region information (“B”) at a second consumer buffer location 429. Here, both “A” and “B” are shown as shaded, to indicated that the consumer 470 (which may be a compositor) will be queueing the content “A” and “B” into a blank buffer in the destination pipeline buffer 1 452.

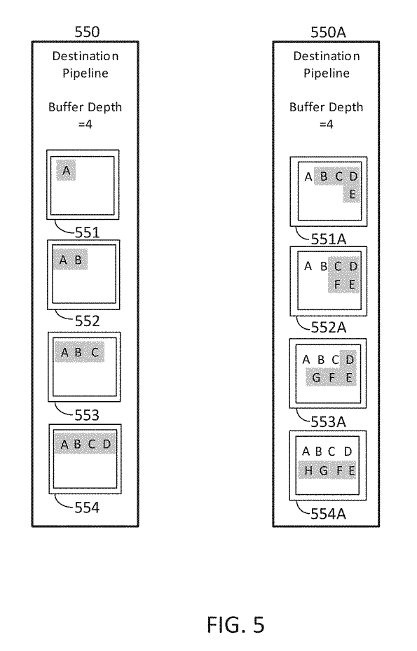

As more updated content is unionized and processed at the producer 420 and fetched by the consumer 470, the consumer has further updated content as shown in the third consumer buffer location 431 (“ABC”) and the fourth consumer buffer location 432 (“ABCD”). As a result, the consumer can pass four buffers to the destination pipeline 450 at once, which is ideal for the destination pipeline 450 with a buffer depth of four, each buffer having the proper updated region information in relation to its preceding buffer. The destination pipeline 450 is depicted with the first four buffers of a given updating image; FIG. 5, which will be described shortly, shows what happens in the buffers of the destination pipeline when the next four buffers are loaded. As shown in FIG. 4, according to the queue of buffers 451-454 in the destination pipeline, the user will first see just A, then AB, then ABC, then ABCD. The display 440, is shown at the moment that the buffer 454 is being displayed.

Referring back to the producer 420, the updated region unionizing component 480 looks at Buffer 2, which comprises updated content “C” in comparison to Buffer 1. However, in comparison to Buffer 0, the updated information in Buffer 2 comprises both “B” and “C.” An aspect of the present disclosure is that the updated region unionizing component 480 takes into account which content is updated in relation to up to four buffers. That is, if less than four buffers have been queued in the producer, the unionizing component 480 will still determine the updated regions for the first subsequent buffer (Buffer 1) and the second subsequent buffer (Buffer 2), and the third subsequent buffer (Buffer 3). Because the updated region of Buffer 2 in comparison to Buffer 0 is “B” and “C,” the producer 420 processes these updated regions together in a unionized manner. Then the updated region fetching component 425 may fetch the updated region “BC” together, and use it to compose a buffer for a third pipeline buffer destination 435 using the previously processed Buffer 0 (comprising “A”).

Next, the unionizing component 480 may look at Buffer 3 and determine that the updated region in comparison to Buffer 0 comprises “BCD.” It may then process that updated region in a unionized manner, which allows the updated region fetching component 425 to fetch the updated region “BCD.” The consumer 470 may then compose a buffer for a fourth pipeline buffer destination 454 comprising “A” and updated region information “BCD.” Again, because the buffer 454 will be blank when the consumer 470 queues a buffer to it, “ABCD” is shown in the consumer 470 as shaded in its entirety. Then, the unionizing component 480 may continue looking at subsequent buffers and process updated regions in a unionized manner for each of four consecutive buffers for as long as the image keeps getting updates. For example, the unionizing component 480 may look at Buffer 4 and process “BCDE” together for fetching by the consumer 470, and then look at Buffer 5 and process “CDFE,” and so on.

Turning now to FIG. 5, a first version of the destination pipeline 550 is shown reflecting the destination pipeline 450 of FIG. 4. The destination pipeline 550A shows the same destination pipeline, but with next set of four buffers 551A-554A that are to be displayed after the first set of buffers 551-554 have been displayed. A significant difference between the composition of the first buffers 551-554 into the destination pipeline 550 and the composition of the next set of buffer 551A-554A into the destination pipeline 550A is that the content of the first buffers 551-554 were composited onto blank buffers, and the content of the second buffers 551A-554A are composited onto “dirty” buffers, meaning buffers that already had a portion of the content rendered on it. In the destination pipeline 550A, buffer 551A is dirty because it already has the existing content “A” from the buffer 551. Therefore, only the new content of “BCDE” has to be composited onto 551A to form the correctly updated image. Similarly, the buffer 552A is dirty because it already has the existing content “B” from the buffer 552. Therefore, only the new content “CDFE” has to be composited onto 552A to form the correctly updated image. Buffers 553A and 554A are similarly composited using an existing dirty buffer and updated content from four buffers' worth of updated regions. This composition in the destination pipeline 550A is possible because the producer 420 of FIG. 4 unionized and processed the four buffers' worth of updated regions for the consumer 470.

Referring back to FIG. 1, the destination pipelines 131-134 depicted illustrate that a number of different destination pipelines are contemplated to be used in accordance with the present disclosure. Each destination pipeline may have different buffer depths. As shown, destination pipeline 1 131 has a buffer depth of four, having four buffers (131A-131D) depicted. Destination pipeline 2 132 shows three buffers and has a buffer depth of three. Destination pipeline 132 is shown as being logically connected to both the display 140 and the processor 110 to illustrate that portions of the pipeline may take place on both on and off the SoC, including on other hardware such as the display 140. Similarly, destination pipeline 3 is shown with five buffers, having a buffer depth of five. Destination pipeline 3 133 may represent a write back for wireless display as described earlier in this disclosure, and is therefore depicted as logically connected to both the SoC 110 and the transceiver 150. Destination pipeline N 134 is depicted having two buffers and a buffer depth of two, and may represent one or more other possible destination pipelines that may be used in accordance with the present disclosure.

It is contemplated that there may be several possible destination pipelines implemented after composition on a single MDP 125, and that each destination pipeline may have different buffer depths. In each case, the buffer depth communication component 129 may communicate the appropriate buffer depth of any destination pipeline being used to the GPU in real-time. Therefore, an updated region unionizing component may unionize varying numbers of subsequent buffers in accordance with the buffer depth communicated thereto. For example, if a buffer depth of a destination pipeline is 2, then the updated region unionizing component may process updated region for two subsequent buffers. If the destination pipeline in another use case is 3, then the same updated region unionizing component may process updated region information for three subsequent buffers, and so forth. It is also contemplated that updated region information may be forwarded for more than one type of destination pipeline at once. for example, updated region information may be forwarded to both a write back for wireless display and a rotation pipeline simultaneously.

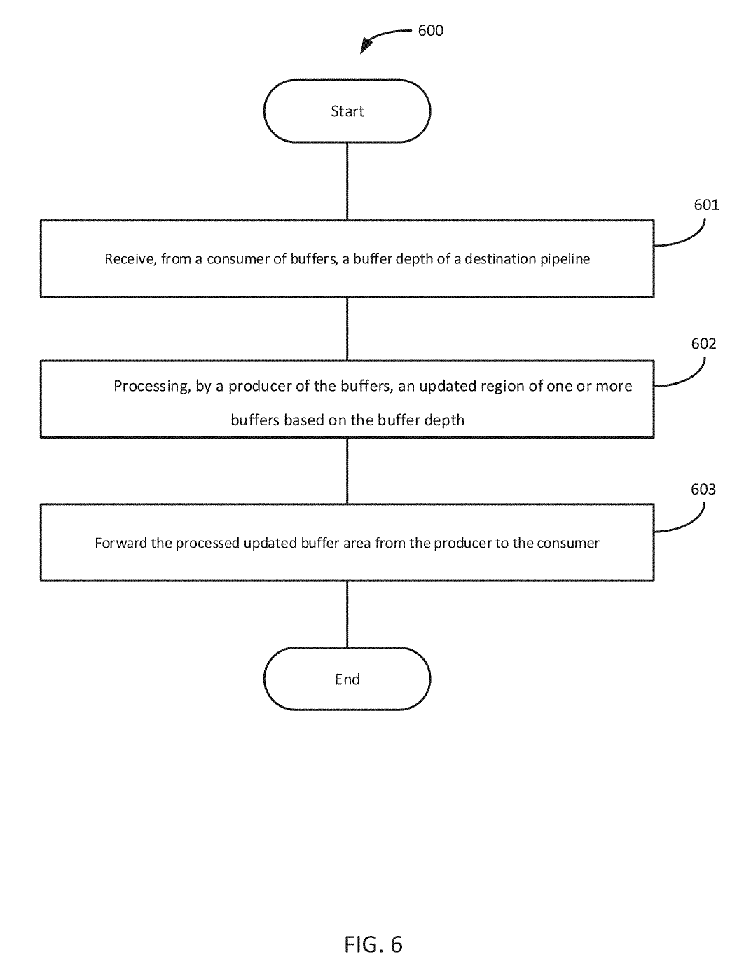

FIG. 6 is a flowchart that may be traversed to perform a method 600 of the present disclosure. First, at step 601, the method may comprise receiving, from a consumer of buffers (e.g., consumer MDP 470 of FIG. 4), a buffer depth of a destination pipeline. Then, at step 602, the method may comprise processing, by a producer of buffers (e.g., at GPU 420 of FIG. 4), an updated region of the buffers based on the buffer depth. The method may then comprise, at step 603, forwarding the processed updated area from the producer to the consumer.

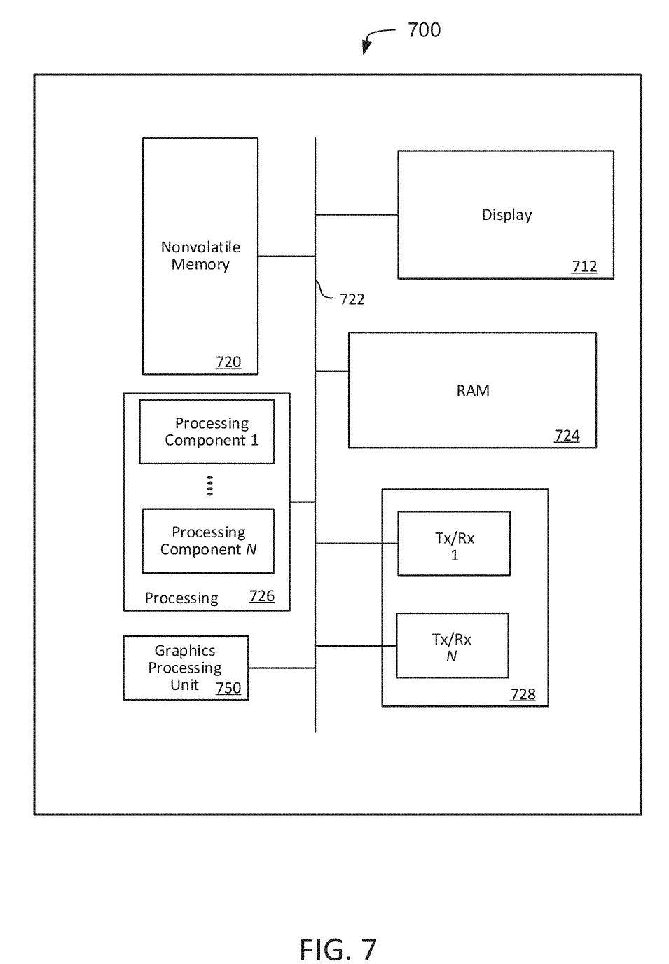

Referring next to FIG. 7, shown is a block diagram depicting physical components of an exemplary content display device 700 that may be utilized to realize a content display device. As shown, the content display device 700 in this embodiment includes a display portion 712, and nonvolatile memory 720 that are coupled to a bus 722 that is also coupled to random access memory (“RAM”) 724, a processing portion (which includes N processing components) 726, a transceiver component 728 that includes N transceivers, and a graphics processing component 750. Although the components depicted in FIG. 7 represent physical components, FIG. 7 is not intended to be a hardware diagram; thus many of the components depicted in FIG. 7 may be realized by common constructs or distributed among additional physical components. Moreover, it is certainly contemplated that other existing and yet-to-be developed physical components and architectures may be utilized to implement the functional components described with reference to FIG. 7.

This display portion 712 generally operates to provide a presentation of content to a user. In several implementations, the display is realized by an LCD or OLED display. In general, the nonvolatile memory 720 functions to store (e.g., persistently store) data and executable code including code that is associated with the functional components described herein. In some embodiments for example, the nonvolatile memory 720 includes bootloader code, modem software, operating system code, file system code, and code to facilitate the implementation of one or more portions of the web browser components.

In many implementations, the nonvolatile memory 720 is realized by flash memory (e.g., NAND or ONENAND™ memory), but it is certainly contemplated that other memory types may be utilized as well. Although it may be possible to execute the code from the nonvolatile memory 720, the executable code in the nonvolatile memory 720 is typically loaded into RAM 724 and executed by one or more of the N processing components in the processing portion 726. In many embodiments, the system memory 130 may be implemented through the nonvolatile memory 720, the RAM 724, or some combination thereof.

The N processing components in connection with RAM 724 generally operate to execute the instructions stored in nonvolatile memory 720 to effectuate the functional components described herein. As one of ordinarily skill in the art will appreciate, the processing portion 726 may include a video processor, modem processor, MDP, DSP, and other processing components. The graphics processing unit (GPU) 750 depicted in FIG. 7 may be used to realize the graphics processing unit functions described herein. For example, the GPU 750 may implement the updated region unionizing component 480.

The depicted transceiver component 728 includes N transceiver chains, which may be used for communicating with external devices via wireless networks. Each of the N transceiver chains may represent a transceiver associated with a particular communication scheme.

In conclusion, embodiments of the present invention reduce bandwidth required for transmitting data between processing components, improve the display of content (e.g., in terms of speed and/or performance) and/or reduce power consumption. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A method for processing buffers of updated content for graphical display on a computing device, the method comprising:
receiving, from a consumer of the buffers, a buffer depth of a destination pipeline,
processing, by a producer of the buffers, an updated region of one or more buffers based on the buffer depth,
forwarding a processed updated buffer area from the producer to the consumer.

2. The method of claim 1, further comprising:
unionizing a plurality of updated regions of a plurality of buffers for the processing.

3. The method of claim 1, wherein the producer is a graphics processing unit.

4. The method of claim 1, wherein the consumer is a mobile display processing unit

5. The method of claim 1, wherein the destination pipeline is write back for a wireless display pipeline.

6. The method of claim 1, wherein the destination pipeline is a rotation pipeline.

7. The method of claim 1, wherein the consumer provides buffers to a plurality of destination pipelines, and further comprising:
processing and forwarding a plurality of updated buffer areas corresponding to the plurality of destination pipelines.

8. A computing device configured to process buffers of updated content for graphical display, the device comprising:
a memory configured to store a plurality of buffers of content for graphical display, wherein one or more of the buffers comprises updated content in relation to one or more other buffers,
a processor configured to produce the buffers comprising updated content, and
a compositor configured to composite the buffers comprising updated content,
wherein the processor and the compositor are configured to:
receive, from the compositor, a buffer depth of a destination pipeline,
process, by the processor of the buffers, an updated region of one or more buffers based on the buffer depth, and
forward a processed updated buffer area from the processor to the compositor.

9. The computing device of claim 8, wherein the processor further configured to unionize a plurality of updated regions of a plurality of buffers in order to process them.

10. The computing device of claim 8, wherein the compositor is a mobile display processing unit.

11. The computing device of claim 8, wherein the destination pipeline is a write back for a wireless display pipeline.

12. The computing device of claim 8, wherein the destination pipeline is a rotation pipeline.

13. The computing device of claim 8, wherein the compositor provides buffers to a plurality of destination pipelines, and the processor is configured to process and forward a plurality of updated buffer areas corresponding to the plurality of destination pipelines.

14. A non-transitory, tangible computer readable storage medium, encoded with processor readable instructions to perform a method for:
receiving, from a consumer of buffers, a buffer depth of a destination pipeline,
processing, by a producer of the buffers, an updated region of one or more buffers based on the buffer depth,
forwarding a processed updated buffer area from the producer to the consumer.

15. The non-transitory, tangible computer readable storage medium of claim 13, wherein the method further comprises:
unionizing a plurality of updated regions of a plurality of buffers for the processing.

16. The non-transitory, tangible computer readable storage medium of claim 14, wherein the producer is a graphics processing unit.

17. The non-transitory, tangible computer readable storage medium of claim 14, wherein the consumer is a mobile display processing unit.

18. The non-transitory, tangible computer readable storage medium of claim 14, wherein the destination pipeline is a write back for wireless display pipeline,

19. The non-transitory, tangible computer readable storage medium of claim 14, wherein the destination pipeline is a rotation pipeline.

20. The non-transitory, tangible computer readable storage medium of claim 14, wherein the consumer provides buffers to a plurality of destination pipelines, and further comprising:
processing and forwarding a plurality of updated buffer areas corresponding to the plurality of destination pipelines.
